(19) United States
(12) Patent Application Publication
(10) Pub. No.: US 2003/0163417 A1
(43) Pub. Date: Aug. 28, 2003

(54) Methods and systems for processing transaction requests

(75) Inventors: Joseph Cachey, Denver, CO (US); Dean Seifert, Parker, CO (US); Mark Thompson, Denver, CO (US); Judy Fleming, Highlands Ranch, CO (US); Carol Darland, Wheatridge, CO (US); Kenneth Algiene, Littleton, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Greenwood Village, CO

(21) Appl. No.: 10/321,783

(22) Filed: Dec. 16, 2002

Related U.S. Application Data
(60) Provisional application No. 60/398,973, filed on Jul. 25, 2002.
(60) Provisional application No. 60/346,363, filed on Jan. 4, 2002.
(60) Provisional application No. 60/342,799, filed on Dec. 19, 2001.

(51) Int. Cl. G06F 17/60

(52) U.S. Cl. 705/39

(57) ABSTRACT

Methods and systems are provided for processing money-order requests and other transactions. A list of prohibited persons is maintained, such as a copy of an OFAC SDN list. When a request is made to execute the transaction, name information is collected from a customer and compared with the list. If the name information matches an entry on the list, the transaction request is declined.

### CROSS REFERENCE TO RELATED APPLICATIONS

This application is a nonprovisional of and claims the benefit of the priority date of each of the following provisional applications: U.S. Prov. Appl. No. 60/342,799 entitled “METHODS AND SYSTEMS FOR PROCESSING MONEY-ORDER REQUESTS,” filed Dec. 19, 2001 by Joseph Cachey III et al.; U.S. Prov. Appl. No. 60/346,363 entitled “METHODS AND SYSTEMS FOR PROCESSING MONEY-ORDER REQUESTS,” filed Jan. 4, 2002 by Joseph Cachey III et al.; and U.S. Prov. Appl. No. 60/398,973, filed Jul. 25, 2002 by Joseph Cachey III et al., entitled “METHODS AND SYSTEMS FOR PROCESSING TRANSACTION REQUESTS,” the entire disclosures of which are herein incorporated by reference for all purposes.

### BACKGROUND OF THE INVENTION

This application relates generally to methods and systems for processing transactions. More specifically, this application relates to methods and systems for checking an identity of a customer before authorizing a transaction.

Currently, the manner in which records are stored for different types of transactions reflect the different character of those transactions. In some instances, the content of records for certain types of transactions, such as money-order transactions, are intentionally limited to information that pertains only to the transaction itself. For example, when a money order is produced, the only information that may be recorded may be such information as the serial number of the money order, the amount of the money order, the location where the money order was produced, and the date and time of sale. Since no information is maintained regarding the purchaser of the money order, it is possible to use a money-order transaction to execute a financial transaction anonymously. This aspect of money-order transactions is not simply a byproduct of a desire to minimize the size of records, but has long been viewed as a feature of money-order products that is attractive to some customers.

In some instances, however, the anonymity provided by such transactions has been abused. This is of particular concern where the transaction is used as part of an illegal purpose or as part of providing funding for an illegal purpose, as may be the case when it is used, for example, in a money-laundering scheme. There is accordingly a general need in the art for structuring certain types of transactions that have a risk of being used for illegal purposes to mitigate or discourage such misuse.

### BRIEF SUMMARY OF THE INVENTION

Embodiments of the invention thus provide methods and systems for processing transactions that reduce their risk of misuse as part of illegal transactions. In the description that follows, a number of different embodiments are described, some of which may be applicable both to transactions that have traditionally been anonymous or nonanonymous. In other instances, certain embodiments are intended specifically for transactions that have traditionally been anonymous. With respect to those transactions, the inventors describe embodiments herein that are contrary to the widespread and conventional expectation that anonymity in such embodiments is preferable.

In one set of embodiments, a method is provided for processing money-order requests, which is an example of a financial transaction that has traditionally been available anonymously. A list of prohibited persons is maintained, such as may correspond to a copy of an OFAC SDN list. When a request is made for a money order by a customer, name information is collected from the customer and compared with the list of prohibited persons. If the name information matches an entry on the list, the request to issue the money order is declined.

In some embodiments, a current copy of the list of prohibited persons may be key in memory associated with each of a plurality of money-order dispensers. In other embodiments, a current copy of the list of prohibited persons may alternatively be kept in a central location that is in communication with each of a plurality of money-order dispensers. The name information may be compared by performing a partial name comparison with entries on the list of prohibited persons, with additional information being requested from the customer if there is a partial match. There are a variety of ways in which the name information may be collected, including by reading a magnetic-stripe card, performing a biometric scan of the customer, reading chip information from a chip card, and optically scanning an instrument, among others. In some embodiments, the collected name information may be periodically reviewed to identify anomalous repetition of certain names, such as by performing a statistical analysis of the collected name information.

In a related set of embodiments that are also applicable to transactions that have traditionally been available anonymously, a list of prohibited persons is also maintained, such as may correspond to a copy of an OFAC SDN list. When a request is made for a money order, name information is collected from a customer. The requested money order is issued with a serial number that is associated with the name information. After the name information is compared with the list of prohibited persons, subsequent payment of the money order may be declined if the name information matches an entry on the list of prohibited persons. The different ways in which the list may be maintained, the comparison of name information performed, and the name information collected are also applicable to this set of embodiments.

In a further embodiment, a method is provided for processing a transaction request, which may comprise a traditionally anonymous transaction request or a traditionally nonanonymous transaction request. A list of prohibited persons is maintained, identifying the prohibited persons in a common language. Name information is collected from a customer in a native language of the name information. The name information in its native language is compared with the common-language list of prohibited persons so that the transaction request may be flagged if the name information corresponds to an entry on the list. Comparison of the name information may be performed with a trained evaluation system, such as an expert system or neural network.

The methods of the present invention may be embodied in a computer-readable storage medium having a computer-readable program embodied therein for directing operation of a computer system. Such a computer system may include a processor, a storage device, and a communications system. The computer-readable program includes instructions for operating the computer system to process transaction requests in accordance with the embodiments described above.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components.

FIGS. 1A and 1B provide schematic illustrations of infrastructure arrangements that may be used to access a list of blocked persons;

FIG. 2 provides a schematic illustration of a computer system that may be configured to perform functions in accordance with embodiments of the invention; and

FIG. 3 provides a flow diagram illustrating certain embodiments of the invention.

### DETAILED DESCRIPTION OF THE INVENTION

Embodiments of the invention permit a transaction to be prevented by comparing the identity of a potential customer against a list of individuals known to present a risk. In certain embodiments, such a list is compiled and made available by a governmental agency. In some instances, there may even be a statutory mandate not to process a transaction with an individual named on the list. Some embodiments are applicable to traditionally anonymous transactions, such as money-order transactions, although the principles of the invention may also be used in embodiments directed to transactions that are traditionally nonanonymous. Other examples of anonymous transactions include a variety of cash transactions.

For example, in one embodiment, the list comprises the Master List of Specially Designated Nationals and Blocked Persons (“SDN list”) compiled by the Office of Foreign Assets Control (“OFAC”) within the U.S. Treasury Department. This is an alphabetical list of all entities and individuals that are blocked under OFAC sanctions programs and is made available to the public. The OFAC has the authority to prohibit certain transactions as part of its effort to combat such illegal activity as terrorism and drug trafficking by blocking the finances of those involved in such activities. The SDN list is currently made available to the public in a variety of ways, including by mail and electronically over the internet at a variety of different computer bulletin board sites. For example, it is available at the U.S. Treasury's Electronic Library on the FedWorld Bulletin Board, which is free to the public and can be accessed using standard communications software or via Telnet, File Transfer Protocol (“FTP”), or the World Wide Web (“WWW”). The SDN list is also available from the Government Printing Office's Federal Bulletin Board, which is free to the public. Certain financial institutions that are members of the U.S. Council on International Banking (“USCIB”) are given access to its INTERCOM bulletin board, which also includes the SDN list. The International Banking Operations Association (“IBOA”) also carries OFAC files, including the SDN list on its “Wildcat” bulletin board. In other embodiments, a different list is used.

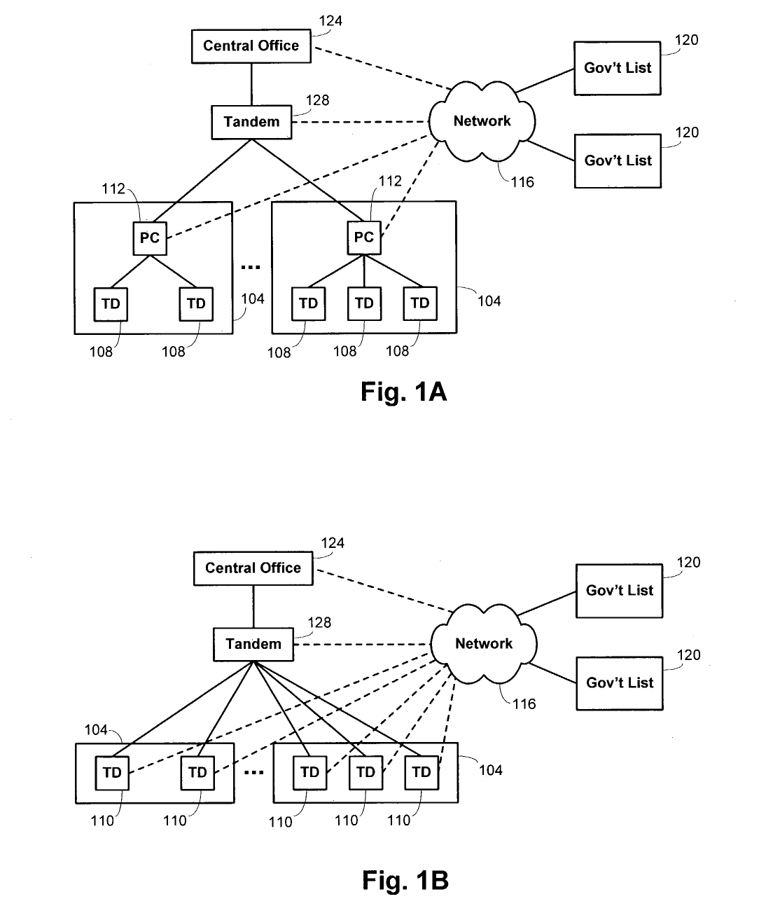

There are a variety of ways in which the relevant list may be accessed at a transaction point. For example, the list may be obtained in hard-copy form from the relevant governmental agency by mail or by fax. In other embodiments, an electronic infrastructure may be used to access an electronic copy of the list. Examples of such arrangements are provided in FIGS. 1A and 1B, and other infrastructure arrangements that may alternatively be used will be evident to those of skill in the art. In the description that follows, a money-order transaction is sometimes used for illustrative purposes as an example of a transaction in which the principles of the invention may be incorporated. The use of such an illustrative embodiment is not intended to be limiting since the principles of the invention may be applied to numerous other transactions in alternative embodiments. The use of a money-order transaction as an illustrative embodiment also provides a model for integrating principles of the invention into traditionally anonymous transactions. It will be understood by those of skill in the art, however, that the principles of the invention may equally well be integrated into transactions that have traditionally been nonanonymous.

In embodiments that use a hard-copy list, each transaction request may collect name information from the customer for human comparison with the hard-copy list. Alternatively, the hard-copy list may be put into electronic form, by data entry or scanning, so that it may then be used in a manner similar to those embodiments where it is directly obtained electronically.

In embodiments where the list is obtained directly in electronic form, different architecture arrangements may be more suitable for different embodiments in which the transaction involves the use of a transaction device at the transaction point. For example, in a money-order transaction, a money order is dispensed from a dispensing device, which thus corresponds to the transaction device. In some instances, the transaction device has relatively little functionality other than its narrow use in the transaction. A money order dispenser, for example, is often not equipped to do anything other than print money orders. Also, the transaction device may have insufficient local memory to store the entire list itself. Such devices may be advantageously used in the arrangement illustrated in FIG. 1A. In this arrangement, each sale location 104 includes a sale computer 112 that is connected to one or more of the transaction devices 108. The sale computers 112 are connected to a tandem computer 124, which is itself connected to a central office computer 124. In an alternative embodiment, the sale computers 112 are connected directly to the central office computer 124.

The list information may be resident on a storage device maintained by any of the computers 112, 124, or 128 so that it may be accessed as necessary by a human when a customer wishes to enter into a transaction; alternatively, the list may be accessed by the transaction device 108 when the customer attempts to engage in a transaction. Each of the computers 112, 124, or 128 may also be connected with a network 116 so that the list may be accessed from one of the available sources 120 for the list. In some embodiments, the network 116 comprises the Internet, but the network 116 may more generally comprise any network that permits access to the available sources 120, including dedicated networks, wide-area networks, local-area networks, and the like. Such access may also be used to obtain updates to the list periodically as may be necessary when the list changes.

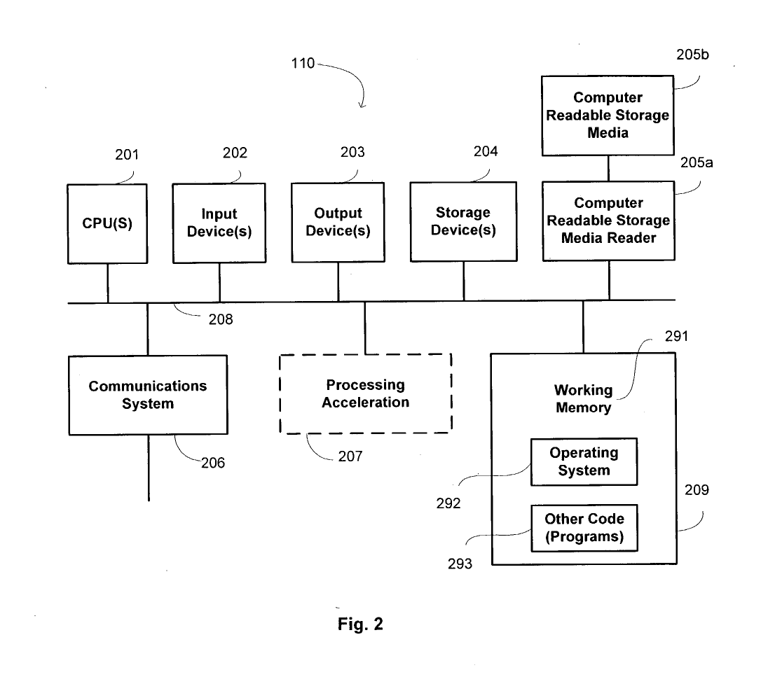

Each sale computer 112 may be configured in a variety of different ways to effect the desired functionality. In one embodiment, the computer has the broad structure shown schematically in FIG. 2, which illustrates how individual system elements may be implemented in a separated or more integrated manner. The computer 112 is shown comprised of hardware elements that are electrically coupled via bus 208, including a processor 201, one or more input devices 202, one or more output devices 203, one or more storage devices 204, a computer-readable storage media reader 205 a, a communications system 206, a processing acceleration unit 207 such as a DSP or special-purpose processor, and a memory 209. The computer-readable storage media reader 205a is further connected to a computer-readable storage medium 205b, the combination comprehensively representing remote, local, fixed, and/or removable storage devices plus storage media for temporarily and/or more permanently containing computer-readable information. The list information is generally stored on the storage devices 204 and may be kept up to date by accessing periodic updates from the relevant source 120 through the internet 116. The communications system 406 is configured to effect communications as needed with transaction devices 108 and to provide a connection to other networks such as the internet 116 and may comprise a wired, wireless, modem, and/or other type of interfacing connection.

The computer 112 also comprises software elements, shown as being currently located within working memory 291, including an operating system 292 and other code 293, such as a program designed to implement methods of the invention. It will be apparent to those skilled in the art that substantial variations may be used in accordance with specific requirements. For example, customized hardware might also be used and/or particular elements might be implemented in hardware, software (including portable software, such as applets), or both. Further, connection to other computing devices such as network input/output devices may be employed.

Generally, the tandem and central office computers 124 and 128 will comprise similar types of hardware and software structures as shown in FIG. 2, although they will generally be larger computers than the sale computers 112. In those embodiments that use them, the sale computers 112 may comprise personal computers.

A more highly functional transaction device 110 may alternatively be connected directly to the network 116 as shown schematically in FIG. 1B. As in the arrangement shown in FIG. 1A, the network 116 may comprise the Internet or any other suitable network that permits access to the list sources. In the embodiment illustrated in FIG. 1B, each of the transaction devices 110 accesses information directly from list source 120 through the network 116. Such access may be performed at the time of a transaction request or, if the transaction devices 110 include sufficient local storage, may be performed on a periodic basis with a copy of the list being stored on each transaction device 110. The greater functionality of the transaction device 110 may also be reflected in an ability to extract information from a variety of different types of instruments, such as from a magnetic-stripe card (such as a credit or debit card) or from a chip card (such as a smart card). An example of a point-of-sale devices that include such functionality are described in the following commonly assigned applications, the entire disclosures of which are incorporated herein by reference for all purposes: U.S. Prov. Pat. Appl. No. 60/147,889, entitled “INTEGRATED POINT OF SALE DEVICE,” filed Aug. 9, 1999 by Randy J. Templeton et al.; U.S. pat. appl. Ser. No. 09/634,901, entitled “POINT OF SALE PAYMENT SYSTEM,” filed Aug. 9, 2000 by Randy J. Templeton et al.; U.S. pat. appl. Ser. No. 10/116,689, entitled “SYSTEMS AND METHODS FOR PERFORMING TRANSACTIONS AT A POINT-OF-SALE,” filed Apr. 3, 2002 by Earney Stoutenburg et al.; U.S. pat. appl. Ser. No. 10/116,733, entitled “SYSTEMS AND METHODS FOR DEPLOYING A POINT-OF-SALE SYSTEM,” filed Apr. 3, 2002 by Earney Stoutenburg et al.; U.S. pat. appl. Ser. No. 10/116,686, entitled “SYSTEMS AND METHODS FOR UTILIZING A POINT-OF-SALE SYSTEM,” filed Apr. 3, 2002 by Earney Stoutenburg et al.; and U.S. pat. appl. Ser. No. 10/116,735, entitled “SYSTEMS AND METHODS FOR CONFIGURING A POINT-OF-SALE SYSTEM,” filed Apr. 3, 2002 by Earney Stoutenburg.

In still other embodiments, the list is maintained directly in memory associated with each of the transaction devices. A copy of the list may be maintained in memory internal or external to the device on such media as memory sticks, PCMIA cards with memory, on an optical disk such as a CD ROM, on a magnetic disk such as a floppy disk, or on any other suitable storage media. In one embodiment where the transaction device 110 is equipped for reading a chip card, the list may be stored on each chip card.

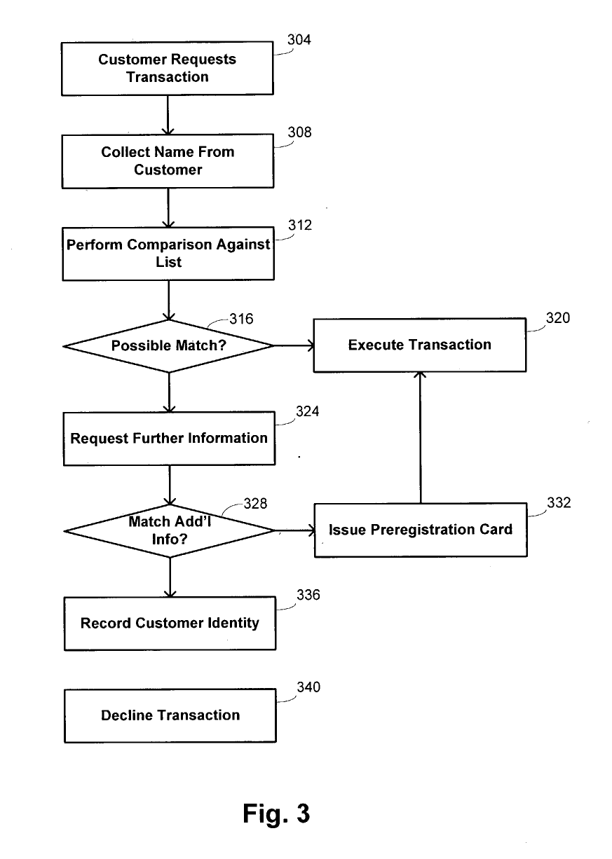

A schematic overview of different ways in which a comparison is made with the list is thus illustrated with the flow diagram of FIG. 3. At block 304, the customer presents himself and makes a request to enter into a transaction, such as by requesting the purchase of a money order. A variety of methods may be used for collecting the name of the customer for comparison with the list. In some cases, all of these methods may be available, but more usually only a subset of the methods will be available according to the architecture adopted. Names may be collected in their native languages or may be transliterated into a standard language for implementation of the system. For example, in one embodiment, the system is configured to operate with names written using a Roman alphabet, and transliterations are used of names that use other alphabets. In another embodiment, transliterations are avoided by collecting the names in whatever alphabet corresponds to the native language of the name. These embodiments are discussed in further detail below.

Thus, in one embodiment, the name of the customer is collected at block 308 by reading a magnetic stripe. The magnetic stripe may be comprised by any of a variety of different types of cards, including a credit card, a debit card, and a driver's license, among others. In a particular embodiment, the magnetic stripe in comprised by a preregistration card that identifies the customer as having previously been screened and found not to be on the list. Usually, the name of the card bearer will be encoded directly as part of the magnetic information on the card, in which case the name is collected directly from the card at block 308. In other instances, the magnetic information may include only reference information that may be used to access a remote database. In such cases, the remote database is accessed with either the communications devices on the computer shown in FIG. 1A or directly by the transaction device if such functionality is available to the transaction device.

In another embodiment, the name of the customer is collected at block 308 from a chip card, such as from a smart card. Usually such a chip card will include the name of the customer directly as part of its memory.

In another embodiment, the name of the customer may be collected at block 308 with an optical scan of a piece of government-issued identification, such as a driver's license, a passport, a resident-alien card, or other such identification instrument. More generally, the optical scan may be performed from any item that includes the name of the customer, including for example, a check, a utility bill, a library notice, or any other document containing the desired information. An optical scan may also be performed of a preregistration card in some embodiments. Such an optical scan may also use an optical character recognition technique to identify the name of the customer directly from the instrument.

In an alternative embodiment, the customer's name may be input directly at block 308 through a device such as a keyboard or touchscreen, either by the customer or by a clerk. The keyboard or touchscreen may correspond to one of the input devices 202 of the sale computer in those embodiments that use a computer, or the keyboard or touchscreen may be connected directly to one of the transaction devices.

In some embodiments, biometric identification is used at block 308 to match biometric information with a database identifying individuals. The biometric information may comprise, for example, data derived from facial features, from fingerprints, from retinal scans, or from other biological characteristics of the individual. The database containing the comparison information may be stored locally or remotely, with access to the database being provided over the communications links described with respect to FIGS. 1A and 1B.

In still other embodiments, the customer may use an electronic device that includes identification information, such as a personal digital assistant (“PDA”), as identification. In such embodiments, the electronic device is connected with the sales computer or directly with the transaction device according to the architectural configuration, and the information is extracted through communications with the electronic device.

The above embodiments for collecting the name from the customer at block 308 use some level of automatic functionality. In further embodiments, a clerk managing the transactions may instead perform the collection. This may be done in some embodiments simply by checking some form of identification provided by the customer, including a driver's license, credit card, debit card, passport, resident-alien card, check, utility bill, or other instrument that includes the desired identification information.

In one specific embodiment, collection of the customer's name at block 308 occurs by having the customer present a preregistration card. Such a preregistration card identifies the customer as one who has previously had his name confirmed as not included on the list and is therefore permitted to engage in transactions. In some embodiments, this status may be subject to updates of the list, which are handled as described below. It is also possible for the preregistration card to be used for additional functions; it may, for example, also function as a loyalty card entitling the customer to certain promotional discounts.

After the name has been collected at block 308, it is compared against the list at block 312. In those embodiments where the name is available in electronic form, the comparison performed at block 312 may be an electronic comparison. Usually such an electronic comparison is performed by comparing the extracted name of the customer directly with the list. In other embodiments, a surrogate for the customer name may be collected at block 308. For example, where the customer presents a preregistration card, the system may simply extract an identification number for the preregistration card and compare that number against a change list that identifies any previously checked customers whose names may have subsequently appeared on the list. It is expected that such a change list will generally be small so that use of a surrogate for the customer's name will increase the efficiency of the transaction. Other surrogates, such as driver's license numbers, passport numbers, etc. may also be used in different embodiments.

In some embodiments, the comparison with the list is performed explicitly by the clerk. A manual comparison may be performed by the clerk, who may have received the list, for example, by mail, fax, or telephone, or by downloading and printing it. In an alternative embodiment, the comparison is performed by having the clerk contact a customer-service or other central authority. In such an embodiment, the clerk provides the central authority with the name of the individual and it responds by approving or disapproving the transaction. In some instances, the central authority may provide an authorization code that is recorded by the clerk.

The clerk may also perform a verification function as part of the comparison at block 312. In those instances where the clerk collects the name of the customer, the verification function is naturally part of the function. For example, if an identification having a photograph of the customer is used to collect the name, the clerk may verify that the photograph is of the individual requesting the transaction. If the identification includes a signature, the clerk may perform a signature comparison. Even in those embodiments where the comparison is performed electronically, the clerk may examine the identification used by the customer to verify the instrument, and is generally required to acknowledge with software running on the sale computer or transaction device that identification has been verified. Such an acknowledgment is then recorded as validatable proof of compliance with any externally imposed verification requirements.

The result of the comparison between the customer's name and the list is evaluated at block 316 to determine whether there is a possible match. In some embodiments, the comparison of names looks for partial matches to account for variations in spelling, the use of nicknames, and variations in transliteration of names that do not use roman letters, among other potential differences between names that otherwise identify the same individual. If there is no match, the transaction is executed at block 320. In the example where a customer has requested a money order, execution of the transaction at block 320 thus comprises delivering the requested money order to the customer.

In other embodiments, alternative techniques may be used to account for variations in spelling and transliterations. For example, in one embodiment, collection of the name at block 308 is performed in the native language of the name. This may be done by any of the methods previously discussed, including extraction from a magnetic stripe, memory on a chip card, or an electronic device such as a PDA, where it has been encoded in the name's native language. The name may also be extracted in the name's native language by optical scanning of a piece of identification issued in that native language, such as a driver's license or passport. As a further alternative, the name may be entered with a keyboard or touchscreen that includes characters in the name's native language. The use of a touchscreen may permit easy reconfiguration to a variety of different alphabets. Thus, for example, a first customer may provide a name using Roman characters, a second customer may provide a name using Arabic characters, a third customer may provide a name using Hebrew characters, a fourth customer may provide a name using Cyrillic characters, etc.

Collection of name information using the alphabet of the name's native language may be accommodated in at least two ways. In one set of embodiments, the list is not restricted to a single alphabet and includes names in their native languages for direct comparison with the collected names. In another set of embodiments, a trained evaluation system at the central office 124, tandem 128, sale computer, or transaction device performs its own transliterations of names to compare with the list. Such a trained evaluation system uses an algorithm that permits self-correcting behavior based on its performance in identifying names, such as an expert system or neural net. Preliminary training of the evaluation system is done by using an appropriate set of certifiable data with known correlations between names that appear on the list and names in their natural language. This known information is compared with evaluations made by the evaluation system to train it in correlating names in different languages with names on the list.

A typical evaluation system that comprises a neural net includes a plurality of nodes, and each node has a weight value associated with it. One layer is an input layer having a plurality of input nodes, and another layer is an output layer having a plurality of output nodes, with at least one layer therebetween. In this embodiment of the invention, the input nodes receive the names of the customers in their native languages and the output nodes generate a designation whether that name appears on the list. In other words, given an input comprising a name in an arbitrary language, the input is combined based upon the organization of the neural network to generate the determination accordingly.

In order to train the neural net, the output values are compared against the correct interpretation with some known samples. If the output value is incorrect when compared against such a test interpretation, the neural net modifies itself to arrive at the correct output value. This is achieved by connecting or disconnecting certain nodes and/or adjusting the weight values of the nodes during the training through a plurality of iterations. Once the training is completed, the resulting layer/node configuration and corresponding weights represents a trained neural net. The trained neural net is then ready to receive unknown data and designate interpretations. Classical neural nets include Kohonen nets, feed-forward nets, and back-propagation nets. These different neural nets have different methods of adjusting the weights and organizing the respective neural net during the training process.

In the event that there is a possible match, further information may be requested at block 324 to ensure that the customer is indeed the person prohibited from engaging in the transaction. For example, such further information may include an address, date of birth, or other identification information. In embodiments where the customer has a preregistration card, this additional information may already be maintained by the system, usually as part of a back-end database at the central office 124 or at the tandem 128, so that it is simply accessed through the communication lines shown in FIGS. 1A and 1B. This additional information is also compared with the information on the list to determine at block 328 whether it also matches. If it does not match and the customer did not use a preregistration card, he may be offered a preregistration card at block 332 to prevent the need for collecting the additional information every time he attempts to engage in a similar transaction. Also, since he does not match one of the individuals on the list, his request execute the transaction is honored at block 320. If both the name of the customer and the additional information match, a record may be made of the customer's identity at block 336 so that it may be provided to any authority if reporting requirements are imposed. In addition, the transaction request is accordingly declined at block 340.

In some embodiments, a procedure is followed to ensure that clerks are complying with the required procedures by collecting all of the names obtained at the sale computers 112 periodically and downloading those names to the central office computer 124. In one such embodiment, the names are downloaded to the central office computer 124 on a daily basis. A review is then performed of the names received from each of the sale computers 112 to identify an improbable presence of a large number of repeated names, particularly of common names (such as “John Smith”). In some embodiments, the review is performed manually.

In other embodiments, the review is conducted as a statistical analysis, which may be automated by using software accessed by the central office computer 124. Such statistical analysis may, in some embodiments, employ common-name usage information consistent with national or more local averages. For example, if the name “Mary Jones” is known to be especially common in State A but not in State B, a certain level of usage at a sale computer 112 located in State B may be flagged as anomalous even if the same level of usage at a sale computer 112 located in State A is not flagged.

Anomalous repetition of names at particular sale-computer locations, particularly of common names, suggests that clerks operating those sale computers may not be complying with the name-collection requirements, but are instead inputting names themselves. Accordingly, the flagged locations are subject to further analysis, perhaps leading to an audit and/or retraining of the noncomplying clerks. It is generally expected that such a name review is more likely to uncover noncompliance in instances where names are input directly by the clerk or customer. Direct extraction of the names from identification devices is believed to be more difficult to circumvent, although the name review may nevertheless uncover schemes developed to avoid compliance even in such embodiments.

The operation of the system as described with respect to FIG. 3 is an example of a system configured to operate in real time. In another set of embodiments, the efficiency of the operation may be improved by batching the comparison functions. The effectiveness of such embodiments may depend to some degree on the type of transaction. For example, where a customer wishes to purchase a money order, the transaction request may be honored by issuing the money order, with the serial number for each money order being associated with the customer identification information and recorded. Periodically, such as overnight daily, the customer identification information is compared for each serial number in batch mode with the list, with any matches to the list being recorded. In such embodiments, the money orders are not negotiable for payment in the absence of a subsequent authorization. This authorization is only provided after referring to the stored serial-number record and confirming that the particular money order was not purchased by an individual on the list. An advantage of such an embodiment is that funds used to purchase the money order have been collected and may therefore be confiscated if desired. Such an arrangement functions as an encashment system and may, for example, be PC-based or web-based for receiving the necessary authorizations to negotiate the money order.

There are other examples where transactions may be executed before comparison is made with the list, thereby also permitting confiscation under appropriate circumstances. For example, in one embodiment, a bill-payment service is provided in which a funds are mailed by the provider on behalf of the customer. Before mailing, however, the relevant identification information is compared against the list, with the mailing being completed only in the event that there are no matches.

Also, while the above description has focused primarily on the identification of the customer initiating the transaction, in other embodiments, other parties identified in the transaction may be compared against the list. For example, in the case where a customer purchases a money order, the name of the payee on the money order is compared against the list in addition to comparing the name of the customer. This may be done at the time of purchase by also requesting that the customer identify the payee, or may be done at the time there is an attempt to negotiate the money order for payment. If the name of the payee is requested at the time of purchase, it may be stored in a database, generally at the tandem 128 or central office 124. Such storage may be used for later comparisons with the list and, in some embodiments, may be used for enhanced customer service by presenting a list of commonly used payees for customers to choose from on an individual basis.

Furthermore, the above description has focused on obtaining the customer's name when an attempt is made to enter into a transaction. In other embodiments, additional information may be obtained routinely, and not merely in response to a possible name match with the list. Such additional information may include the address of the customer and perhaps also his telephone number. In certain embodiments, greater convenience may be afforded to the customer with a facility for preregistering before a specific transaction is attempted. In some instances, the facility may also permit a specific transaction to be staged so that a customer can specify any terms for the transaction in advance. Such a facility may be provided as an automated telephone service or at a kiosk in different embodiments.

While the discussion has provide examples of specific embodiments in which customers attempt to purchase money orders, it will be evident that the principles of the invention may also be applied to the purchase of other financially based items that may otherwise be made anonymously. For example, the purchase of gift certificates, vendor payments, prepaid stored-value cards, and payroll systems, among others, may all use aspects of the invention. Furthermore, aspects of the invention may be used in transactions that have not traditionally been anonymous, in addition to their use in transactions that are conventionally anonymous.

Having described several embodiments, it will be recognized by those of skill in the art that various modifications, alternative constructions, and equivalents may be used without departing from the spirit of the invention. Accordingly, the above description should not be taken as limiting the scope of the invention, which is defined in the following claims.

What is claimed is:

1. A method for processing a money-order request, the method comprising:
maintaining a list of prohibited persons;
collecting name information from a customer as part of the money-order request;
comparing the name information with the list of prohibited persons; and
flagging the money-order request if the name information matches an entry on the list of prohibited persons.

2. The method recited in claim 1 further comprising declining to issue the money order.

3. The method recited in claim 1 wherein maintaining the list of prohibited persons comprises keeping a current copy of the list in memory associated with each of a plurality of money-order dispensers.

4. The method recited in claim 1 wherein maintaining the list of prohibited persons comprises keeping a current copy of the list at a central location that is in communication with each of a plurality of money-order dispensers.

5. The method recited in claim 1 wherein comparing the name information comprises performing a partial name comparison with entries on the list of prohibited persons.

6. The method recited in claim 5 further comprising requesting additional identification information from the customer if there is a partial match between the name information and one of the entries.

7. The method recited in claim 1 wherein collecting name information comprises reading a magnetic-stripe card.

8. The method recited in claim 7 wherein the magnetic-stripe card comprises a preregistration card.

9. The method recited in claim 8 wherein comparing the name information comprises accessing a database of information having an entry corresponding to owner information for the preregistration card.

10. The method recited in claim 1 wherein collecting name information comprises performing a biometric scan of the customer.

11. The method recited in claim 1 wherein collecting name information comprises reading chip information from a chip card.

12. The method recited in claim 11 wherein the list is maintained on the chip card.

13. The method recited in claim 1 wherein collecting name information comprises optically scanning an instrument.

14. The method recited in claim 1 wherein the list comprises a copy of an OFAC SDN list.

15. The method recited in claim 1 further comprising periodically reviewing collected name information to identify anomalous repetition of certain names.

16. The method recited in claim 15 wherein reviewing collected name information comprises performing a statistical analysis of collected name information.

17. A method for processing a money-order request, the method comprising:
maintaining a list of prohibited persons;
collecting name information from a customer;
issuing a requested money order, the money order having a serial number;
associating the name information with the serial number;
comparing the name information with the list of prohibited persons; and
declining to authorize payment of the money order if the name information matches an entry on the list of prohibited persons.

18. The method recited in claim 17 wherein comparing the name information comprises performing a partial name comparison with entries on the list of prohibited persons.

19. The method recited in claim 28 further comprising requesting additional identification information from the customer if there is a partial match between the name information and one of the entries.

20. The method recited in claim 17 wherein collecting name information comprises reading a magnetic-stripe card.

21. The method recited in claim 20 wherein the magnetic-stripe card comprises a preregistration card.

22. The method recited in claim 21 wherein comparing the name information comprises accessing a database of information having an entry corresponding to owner information for the preregistration card.

23. The method recited in claim 17 wherein collecting name information comprises performing a biometric scan of the customer.

24. The method recited in claim 17 wherein collecting name information comprises reading chip information from a chip card.

25. The method recited in claim 24 wherein the list is maintained on the chip card.

26. The method recited in claim 17 wherein collecting name information comprises optically scanning an instrument.

27. The method recited in claim 17 further comprising periodically reviewing collected name information to identify anomalous repetition of certain names.

28. A computer-readable storage medium having a computer-readable program embodied therein for directing operation of a computer system including a communications system, a processor, and a storage device, wherein the computer-readable program includes instructions for operating the computer system to process a money-order request in accordance with the following:
maintaining a list of prohibited persons on the storage device;
collecting name information from a customer through the communications system as part of the money-order request;
comparing the name information with the list of prohibited persons with the processor; and
declining to issue the money order if the name information matches an entry on the list of prohibited persons.

29. The computer-readable storage medium recited in claim 28 wherein comparing the name information comprises performing a partial name comparison with entries on the list of prohibited persons.

30. The computer-readable storage medium recited in claim 28 wherein the computer-readable program further includes instructions for periodically reviewing collected name information to identify anomalous repetition of certain names.

31. A computer-readable storage medium having a computer-readable program embodied therein for directing operation of a computer system including a communications system, a processor, and a storage device, wherein the computer-readable program includes instructions for operating the computer system to process a money-order request in accordance with the following:
maintaining a list of prohibited persons on the storage device;
collecting name information from a customer through the communications system;
instructing a money-order dispenser to issue a requested money order with the communications system, the money order having a serial number;
associating the name information with the serial number with the processor;
comparing the name information with the list of prohibited persons with the processor; and
declining to authorize payment of the money order if the name information matches an entry on the list of prohibited persons.

32. The computer-readable storage medium recited in claim 31 wherein comparing the name information comprises performing a partial name comparison with entries on the list of prohibited persons.

33. The computer-readable storage medium recited in claim 31 wherein the computer-readable program further includes instructions for periodically reviewing collected name information to identify anomalous repetition of certain names.

34. A method for processing a transaction request, the method comprising:
maintaining a list of prohibited persons, wherein the list identifies the prohibited persons in a common language;
collecting name information from a customer, wherein the name information is in a native language of the name information;
comparing the name information in the native language with the list of prohibited persons in the common language; and
flagging the transaction request if the name information corresponds to an entry on the list of prohibited persons.

35. The method recited in claim 34 wherein comparing the name information in the native language with the list of prohibited persons is performed with a trained evaluation system.

36. The method recited in claim 35 wherein the trained evaluation system comprises an expert system.

37. The method recited in claim 35 wherein the trained evaluation system comprises a neural network.

38. The method recited in claim 34 wherein the transaction request comprises a traditionally anonymous transaction request.

39. The method recited in claim 34 wherein the transaction request comprises a traditionally nonanonymous transaction request.

40. The method recited in claim 34 wherein collecting name information comprises optically scanning an instrument in the native language.

41. The method recited in claim 34 wherein collecting name information comprises keying the name information in the native language.

42. A computer-readable storage medium having a computer-readable program embodied therein for directing operation of a computer system including a communications system, a processor, and a storage device, wherein the computer-readable program includes instructions for operating the computer system to process a money-order request in accordance with the following:
maintaining a list of prohibited persons on the storage device, wherein the list identifies the prohibited persons in a common language;
collecting name information from a customer through the communications system, wherein the name information is in a native language of the name information;
comparing the name information in the native language with the list of prohibited persons in the common language with the processor; and
declining to execute the transaction request if the name information corresponds to an entry on the list of prohibited persons.

43. The computer-readable storage medium recited in claim 42 wherein collecting name information comprises optically scanning an instrument in the native language.

44. The computer-readable storage medium recited in claim 42 wherein collecting name information comprises keying the name information in the native language.
